(19) United States
(12) Patent Application Publication
(10) Pub. No.: US 2024/0290223 A1
(43) Pub. Date: Aug. 29, 2024

(54) HUMAN CERVICAL VERTEBRA SIMULATION DEVICE AS WELL AS TEACHING ROBOT ORIENTED TO ROTATION-TRACTION MANIPULATION TRAINING

(71) Applicant: WANGJING HOSPITAL, CHINA ACADEMY OF CHINESE MEDICAL SCIENCES (ORTHOPEDICS RESEARCH INSTITUTE, CHINA, Beijing (CN)

(72) Inventors: Liguo ZHU, Beijing (CN); Minshan FENG, Beijing (CN); Jian LI, Beijing (CN)

(21) Appl. No.: 18/025,852

(22) PCT Filed: Sep. 30, 2022
(86) PCT No.: PCT/CN2022/123246

§ 371 Date: Mar. 10, 2023

(30) Foreign Application Priority Data
Sep. 22, 2022 (CN) 202211157788.8

(51) Int. Cl. G09B 23/32

(52) U.S. Cl. CPC G09B 23/32

(57) ABSTRACT

Two degrees of freedom of rotation and pitching of the neck of a patient are simulated by arranging a neck motion simulation module, and the simulation of individualized cervical vertebra motion changes and states can be achieved in a mechanical manner by providing a cervical vertebra pre-traction and lifting-pulling simulation module. Due to the individualized difference and the difference of symptoms, the force for the human cervical vertebra in the pre-traction and lifting-pulling processes also has the individualized difference. The mechanical characteristics of the individualized human cervical vertebra can be simulated under the lifting-rotating manipulation of a student by providing a lifting-pulling damping mechanism and a pre-traction damping mechanism. In accordance with the present disclosure, a practice, training and examination platform is provided for beginners of the rotation-traction manipulation, a practice platform and technical support are provided for rapidly developing qualified rotation-traction manipulation operators with high quality.

### TECHNICAL FIELD

The present disclosure belongs to the field of medical apparatus and instruments, and relates to medical training teaching equipment, and in particular relates to a human cervical vertebra simulation device as well as a teaching robot oriented to rotation-traction manipulation training.

### BACKGROUND

Cervical spondylosis, also known as cervical vertebra syndrome, is a general term for cervical osteoarthritis, cervical osteophytosis, cervical nerve root syndrome and cervical herniated disc, which is a disorder based on degenerative pathological changes and is a common and frequent disease in orthopedics, mainly divided into neck pain, cervical radiculopathy, cervical spondylotic myelopathy, cervical spondylotic arteriopathy, sympathetic type of cervical spondylosis, and esophageal compressed type cervical spondylosis. Among them, the neck pain and the cervical radiculopathy account for a great proportion.

At present, the means for treating cervical spondylosis are mainly divided into surgical therapy and conservative therapy. As the manipulation therapy is free of the inconvenience of taking medicine and the pain of acupuncture, and the treatment effect, especially for neck pain and cervical radiculopathy, is better, it is more easily accepted by patients. Therefore, in the field of cervical spondylosis treatment, manipulation therapy is recognized as one of the most effective means of treating neck pain and cervical radiculopathy. The manipulation used in the treatment of cervical spondylosis are a rotating manipulation and a pulling manipulation, both of which are performed directly on the head of the patient during the treatment, require a high level of skill on physicians and are more complex in operation process. During the application of manipulation, it is difficult for the patient to really relax, thereby directly affecting the therapeutic effect. Experts in Wang Jing Hospital of CACMS (China Academy of Chinese Medical Sciences) deeply analyzed the motion mechanisms of the rotating manipulation and the pulling manipulation, performed adjustment and innovation on the traditional manipulation in combination with long-term clinical practice and research, increased the operability of the manipulation and the acceptability of the patient to the greatest extent on the basis of achieving the manipulation therapy, and named such manipulation as a rotation-traction manipulation. The rotation-traction manipulation is mainly divided into a rotating operation and a lifting-pulling operation: the first is the rotating, that is, the physician guides the patient to complete the active horizontal rotation of the head to the limit angle, and then guides the patient to rotate the head again after the maximum flexion so as to reach a sense of fixation; the stable state of the head and neck space state of the patient after localization is achieved, and the elastic characteristic (stiffness) is not embodied in the rotating direction; the lifting-pulling is then completed by the physician, including three parts: a pre-loading part (pre-traction), a lifting-pulling part, and a recovery part. During pre-loading, the physician supports the lower jaw of the patient with the elbow and slightly pulls the lower jaw upwards for 3 to 5 seconds, with the body direction having variable stiffness characteristic. During lifting-pulling, the physician advises the patient to relax muscles, and then lifts the lower jaw upwards rapidly with short force at the elbow. One or more snapping sound can be heard for a successful operation; after completing the lifting-pulling, the head of the patient recovers slowly.

Despite of the great improvement from operability to acceptability of the “rotation-traction manipulation” compared to conventional manipulations, the achievement of the manipulation requires a great deal of clinical experience, and the safety, effectiveness of the manipulation by beginners and patient acceptability have been greatly criticized. While in the prior art, as the training scheme for beginners is only limited to explanation and teaching demonstration in a classroom and rarely provides practical opportunity, the manipulation mastering process of the beginner is low-efficient and slow, and the promotion and popularization of the rotation-traction manipulation are seriously restricted. Therefore, it is necessary to develop a cervical vertebra mechanical property simulation device oriented to rotation-traction manipulation training to provide a practice platform for beginners, but there is no related device in the prior art.

### SUMMARY

One of the objectives of the present disclosure is to provide a human cervical vertebra simulation device oriented to rotation-traction manipulation training, which can simulate the biomechanical state of the cervical vertebra of a patient and provides a practice platform for beginners, thus solving the problems that in the prior art, as the training scheme for beginners is only limited to explanation and teaching demonstration in a classroom and rarely provides practical opportunity, the manipulation mastering process of the beginner is low-efficient and slow, and the promotion and popularization of the rotation-traction manipulation are seriously restricted.

To achieve the objective above, the present disclosure provides the following solutions.

A man cervical vertebra simulation device oriented to rotation-traction manipulation training is provided. The human cervical vertebra simulation device includes:
a neck motion simulation module, including a rotating housing, a neck connecting plate, a rotating drive, a pitching drive, and a head mounting plate, where the neck connecting plate is located below the rotating housing, the rotating drive is arranged on the neck connecting plate and is connected to a lower part of the rotating housing; the rotating drive is configured to drive the rotating housing to rotate so as to simulate rotation action of a neck of a patient during rotation-traction manipulation; the pitching drive is mounted at an upper part of the rotating housing by a fastener, is connected to the head mounting plate and configured to drive the head mounting plate to rotate with respect to the rotating housing, thus simulating pitch action of the neck of the patient during the rotation-traction manipulation; and
a cervical vertebra pre-traction and lifting-pulling simulation module, including a shell, a pre-traction module, and a lifting-pulling module; the pre-traction module is arranged in the shell, and includes a pre-traction damping mechanism, and a neck connecting plate, an adapter plate, a tension and pressure detection device and a pre-traction slide block connected in sequence from top to bottom; an upper part of the neck connecting plate penetrates through the housing and is connected to the neck connecting plate; the pre-traction damping mechanism is arranged on the shell and configured to apply pre-traction resistance on the pre-traction slide block; the lifting-pulling module is arranged in the shell and includes a lifting-pulling slide block and a lifting-pulling damping mechanism; the lifting-pulling slide block is located below the pre-traction slide block, the pre-traction slide block is connected to the lifting-pulling slide block by means of a pre-traction-lifting-pulling connecting pin; a lower part of the pre-traction-lifting-pulling connecting pin penetrates through the lifting-pulling slide block and is connected to a lifting-pulling baffle; when the pre-traction slide block is not in a pre-traction state, the lifting-pulling baffle is located below the lifting-pulling slide block and spaced from the lifting-pulling slide block; when the pre-traction slide block is in a pre-traction completing state, the lifting-pulling baffle abuts against the lifting-pulling slide block and continues to pull the pre-traction slide block; the lifting-pulling slide block can be lifted and pulled by the lifting-pulling baffle so as to simulate rigidity sudden change of cervical vertebra in the lifting-pulling process; and the lifting-pulling damping mechanism is arranged on the shell and configured to apply lifting-pulling resistance to the lifting-pulling slide block.

Alternatively, the rotating drive includes a rotating part rotating transformer, and a rotating motor, a rotating part reducer, a rotating torque detection device and a rotating driving plate connected in sequence; the rotating motor is arranged on the neck connecting plate, and the rotating driving plate is connected to the rotating housing, and the rotating part rotating transformer is connected to a rotating shaft of the rotating motor so as to measure a rotation angle of the rotating shaft.

Alternatively, the pitching drive includes a pitching part rotating transformer, and a pitching motor, a pitching part reducer, a pitching torque detection device and a pitching driving plate which are connected in sequence; the pitching motor is arranged on an inner wall of the rotating housing, the pitching driving plate is connected to a side of the head mounting plate, and a pitching follower plate and a driven support are connected to an other side of the head mounting plate in sequence; the driven support is rotatably connected to an other side of the rotating housing by means of a pitching driven shaft, and the pitching part rotating transformer is connected to the pitching driven shaft so as to measure a pitching angle of the pitching driven shaft.

Alternatively, the pitching torque detection device is a pitching torque transducer, and the rotating torque detection device is a rotating torque transducer.

Alternatively, the tension and pressure detection device is a tension and pressure transducer.

Alternatively, the rotating part reducer and the pitching part reducer are both harmonic reducers.

Alternatively, loading curved surfaces are symmetrically arranged on two sides of the pre-traction slide block and gradually incline outwards from top to bottom.

Alternatively, the pre-traction damping mechanism includes a variable-stiffness driving mechanism and a first roller; the variable-stiffness driving mechanism is mounted on the shell, the first roller is rotatably mounted on the variable-stiffness driving mechanism, the first roller is pressed against each loading curved surface by the variable-stiffness driving mechanism; two sides of the pre-traction slide block are arranged on the pre-traction damping mechanism, respectively; and pre-traction resistance applied to the pre-traction slide block by the pre-traction damping mechanism is adjusted by adjusting pressing force of the first roller to the loading curved surfaces.

Alternatively, the variable-stiffness driving mechanism includes:
a transverse polished shaft, where two ends of the transverse polished shaft are fixedly arranged on two sidewalls of the shell;
a first pre-traction loading plate, where the first pre-traction loading plate is slidingly sleeved on the transverse polished shaft;
a second pre-traction loading plate, where the second pre-traction loading plate is slidingly sleeved on the transverse polished shaft and located between the first pre-traction loading plate and the pre-traction slide block; the second pre-traction loading plate is connected to the first pre-traction loading plate by means of a pre-traction spring, and the first roller is mounted on a side, away from the first pre-traction loading plate, of the second pre-traction loading plate;
a pre-traction loading shaft, where an end of the pre-traction loading shaft penetrates through the first pre-traction loading plate and is threaded to the first pre-traction loading plate;
a pre-traction stiffness adjusting motor, where the pre-traction stiffness adjusting motor is arranged on a sidewall of the shell, a stiffness adjusting gear is connected to an output shaft of the pre-traction stiffness adjusting motor, the stiffness adjusting gear is meshed with a driven gear, the stiffness adjusting gear and the driven gear are both rotatably mounted on the sidewall of the shell, the driven gear is connected to an other end of the pre-traction loading shaft, the pre-traction stiffness adjusting motor is able to drive the first pre-traction loading plate to move towards the second pre-traction loading plate, thus adjusting the pressing force of the first roller on the loading curved surface; and
a linear displacement transducer, where the linear displacement transducer is arranged on the sidewall of the shell and is connected to the first pre-traction loading plate so as to detect a position of the first pre-traction loading plate on the transverse polished shaft.

Alternatively, the lifting-pulling damping mechanism includes:
a lifting-pulling base, where the lifting-pulling base is connected to a lower part of the lifting-pulling slide block;
a lifting-pulling housing, where the lifting-pulling housing is arranged on the lifting-pulling base and located on a side of the lifting-pulling slide block, and a sliding chute cavity parallel to the transverse polished shaft is formed inside the lifting-pulling housing;
a first lifting-pulling loading pin, where the first lifting-pulling loading pin is slidingly nested in the sliding chute cavity;
a second lifting-pulling loading pin, where the second lifting-pulling loading pin is slidingly nested in the sliding chute cavity and located between the first lifting-pulling loading pin and the lifting-pulling slide block; the second lifting-pulling loading pin is connected to the first lifting-pulling loading pin by means of a lifting-pulling spring, a second roller is mounted on an end, away from the first lifting-pulling loading pin, of the second lifting-pulling loading pin, and the second roller is in contact with a sidewall of the lifting-pulling slide block; and
a linear push rod, where the linear push rod is arranged on the lifting-pulling base by means of a linear push rod fixing seat, the linear push rod is connected to the first lifting-pulling loading pin and is able to drive the first lifting-pulling loading pin to move towards, or away from, the second lifting-pulling loading pin, thereby adjusting pressing force of the second roller on the sidewall of the lifting-pulling slide block.

Alternatively, the cervical vertebra pre-traction and lifting-pulling simulation module further includes a longitudinal polished shaft, where two ends of the longitudinal polished shaft are fixedly connected to an upper part and a lower part of the shell;
the adapter plate, the pre-traction slide block and the lifting-pulling slide block are slidingly sleeved on the longitudinal polished shaft; and
a base sliding supporting plate is connected to a lower part of the lifting-pulling base, the base sliding supporting plate is slidingly sleeved on the longitudinal polished shaft; a base stop block is fixedly arranged on the longitudinal polished shaft between the lifting-pulling base and the base sliding supporting plate, and the base stop block is able to limit a lower limit of downward movement of the lifting-pulling plate base and an upper limit of upward movement of the base sliding supporting plate.

Alternatively, two longitudinal polished shafts are provided. The adapter plate, the pre-traction slide block, the lifting-pulling slide block and the base sliding supporting plate are slidingly sleeved on the two longitudinal polished shafts.

Alternatively, the adapter plate, the pre-traction slide block, the lifting-pulling slide block and the base sliding supporting plate are in sliding fit with the longitudinal polished shafts by means of linear bearings.

Alternatively, the base sliding supporting plate is a U-shaped supporting plate, and the two ends of the U-shaped supporting plate are connected to the lower part of the lifting-pulling base.

Alternatively, an upper surface of the lifting-pulling baffle is provided with a rubber gasket, and the lifting-pulling baffle abuts against a bottom of the lifting-pulling slide block through the rubber gasket.

It is further provided a teaching robot oriented to rotation-traction manipulation training. The teaching robot includes a cloud platform, a control system, and the human cervical vertebra simulation device oriented to rotation-traction manipulation training, where the control system is in communication connection with the cloud platform, the rotating drive, the pitching drive, the pre-traction damping mechanism, the tension and pressure detection device and the lifting-pulling damping mechanism; the cloud platform is configured to display, process and analyze operating parameters of the rotating drive, the pitching drive, the pre-traction damping mechanism, the tension and pressure detection device and the lifting-pulling damping mechanism.

Alternatively, the teaching robot includes a simulated human head and a base, where the simulated human head is arranged on the head mounting plate, a lower part of the shell is connected to the base by means of a mechanical interface, and the control system is arranged in the base.

Compared with the prior art, the present disclosure obtains the following technical effects.

The human cervical vertebra simulation device oriented to rotation-traction manipulation training is provided. The device is simple and novel in structure. Two degrees of freedom of rotation and pitching of the neck of a patient are simulated by arranging the neck motion simulation module, and the simulation of individualized cervical vertebra motion changes and states can be achieved in a mechanical manner by providing the cervical vertebra pre-traction and lifting-pulling simulation module. Due to the individualized difference and the difference of symptoms, the force for the human cervical vertebra in the pre-traction and lifting-pulling processes also has the individualized difference. The mechanical characteristics of the individualized human cervical vertebra can be simulated under the rotation-traction manipulation of a student by providing a lifting-pulling damping mechanism and a pre-traction damping mechanism

The human cervical vertebra simulation device oriented to rotation-traction manipulation training can, on the one hand, provide a practice platform for the beginners, and on the other hand, provide examination for each stage of the rotation-traction manipulation, thereby providing a reference for the qualification of physicians to be able to clinically apply the rotation-traction manipulation. In accordance with the present disclosure, a practice, training and examination platform is provided for beginners of the rotation-traction manipulation, a practice platform and technical support are provided for rapidly developing qualified rotation-traction manipulation operators with high quality, and high scientific research value and practical value are achieved.

The present disclosure further provides the teaching robot including the human cervical vertebra simulation device. The robot is provided with a corresponding control system, which not only can simulate the biomechanical states of cervical vertebrae of different symptoms, but also can perform TCM rotation-traction manipulation teaching oriented to individualized symptoms. The purpose of combining practice, training and examination is truly achieved, a practice platform and technical support are provided for rapidly developing qualified rotation-traction manipulation operators with high quality, and high scientific research value and practical value are achieved.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a human cervical vertebra simulation device oriented to rotation-traction manipulation training in accordance with the embodiment of the present disclosure;

FIG. 2 is a schematic structural diagram of a neck motion simulation module in accordance with the embodiment of the present disclosure;

FIG. 3 is a schematic structural diagram of a cervical vertebra pre-traction and lifting-pulling simulation module in accordance with the embodiment of the present disclosure;

FIG. 4 is a side view of the cervical vertebra pre-traction and lifting-pulling simulation module in accordance with the embodiment of the present disclosure;

FIG. 5 is a sectional diagram of the cervical vertebra pre-traction and lifting-pulling simulation module in accordance with the embodiment of the present disclosure;

FIG. 6 is an axonometric drawing of a pre-traction module in accordance with the embodiment of the present disclosure;

FIG. 7 is a sectional diagram of the pre-traction module in accordance with the embodiment of the present disclosure;

FIG. 8 is a top view of the pre-traction module in accordance with the embodiment of the present disclosure;

FIG. 9 is a schematic diagram showing mounting a pre-traction spring in accordance with the embodiment of the present disclosure;

FIG. 10 is a schematic structural diagram of a pre-traction slide block in accordance with the embodiment of the present disclosure;

FIG. 11 is a sectional diagram of a lifting-pulling module in accordance with the embodiment of the present disclosure;

FIG. 12 is an axonometric drawing of the lifting-pulling module in accordance with the embodiment of the present disclosure;

FIG. 13 is a schematic structural diagram of a lifting-pulling slide block in accordance with the embodiment of the present disclosure;

FIG. 14 is a front view of the lifting-pulling slide block in accordance with the embodiment of the present disclosure;

### REFERENCE NUMERALS

1—neck motion simulation module; 1-1—pitching follower plate; 1-2—pitching motor; 1-3—pitching motor shaft; 1-4—head mounting plate; 1-5—pitching driving plate; 1-6—pitching torque transducer adapter plate; 1-7—bolt; 1-8—pitching torque transducer; 1-9—pitching harmonic reducer; 1-10—rotating housing; 1-11—neck connecting plate; 1-12—rotating part output shaft; 1-13—rotating motor shaft; 1-14—rotating part rotating transformer; 1-15—rotating motor; 1-16—rotating harmonic reducer; 1-17—flexspline output adapter plate; 1-18—rotating torque transducer; 1-19—rotating driving plate; 1-20—deep groove ball bearing; 1-21—pitching part rotating transformer; 1-22—pitching driven shaft; 1-23—driven support; 1-24—pitching rotating transformer supporting seat;
2—cervical vertebra pre-traction and lifting-pulling simulation module; 2-1—neck connecting plate; 2-2—adapter plate; 2-3—linear bearing; 2-4—shell; 2-5—displacement transducer mounting plate; 2-6—linear displacement transducer; 2-7—pre-traction stiffness adjusting motor; 2-8—lifting-pulling base; 2-9—base sliding supporting plate; 2-10—linear displacement transducer; 2-7—pre-traction stiffness adjusting motor; 2-8—lifting-pulling base; 2-9—base sliding supporting plate; 2-10—base movement displacement transducer; 2-11—base push rod holder; 2-12—lifting-pulling base linear push rod; 2-13—base push rod pillar; 2-14—linear bearing; 2-15—base stop block; 2-16—pre-traction module; 2-16-1—deep groove ball bearing; 2-16-2—pre-traction loading shaft; 2-16-3—thrust bearing; 2-16-4—linear bearing; 2-16-5—pre-traction-lifting-pulling connecting pin; 2-16-6—first pre-traction loading plate; 2-16-7—second pre-traction loading plate; 2-17—pre-traction stiffness measurement tooling plate; 2-18—tension and pressure transducer; 2-19—transverse polished shaft fixing seat; 2-20—longitudinal polished shaft fixing seat; 2-21—stiffness adjusting gear; 2-22—driven gear; 2-23—longitudinal polished shaft; 2-24—pre-traction slide block; 2-25—lifting-pulling module; 2-25-1—lifting-pulling housing; 2-25-2—lifting-pulling spring; 2-25-3—first lifting-pulling loading pin; 2-25-4—linear push rod; 2-25-5—second roller; 2-25-6—lifting-pulling baffle; 2-25-7—lifting-pulling linear bearing; 2-25-8—lifting-pulling slide block; 2-25-9—rubber gasket; 2-25-10—linear push rod fixing seat; 2-25-11—second lifting-pulling loading pin; 2-26—transverse linear bearing; 2-27—transverse polished shaft; 2-28—pre-traction spring; 2-29—pulley block; 2-30—first roller;
3—mechanical interface.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure. One of the objectives of the present disclosure is to provide a human cervical vertebra simulation device oriented to rotation-traction manipulation training, which can simulate the biomechanical state of the cervical vertebra of a patient and provides a practice platform for beginners, thus solving the problems that in the prior art, as the training scheme for beginners is only limited to explanation and teaching demonstration in a classroom and rarely provides practical opportunity, the manipulation mastering process of the beginner is low-efficient and slow, and the promotion and popularization of the rotation-traction manipulation are seriously restricted.

The other objective of the present disclosure is to provide a teaching robot with the human cervical vertebra simulation device oriented to rotation-traction manipulation training.

To make the objectives, features and advantages of the present disclosure more apparently and understandably, the present disclosure is further described in detail below with reference to the accompanying drawings and specific embodiments.

### Embodiment 1

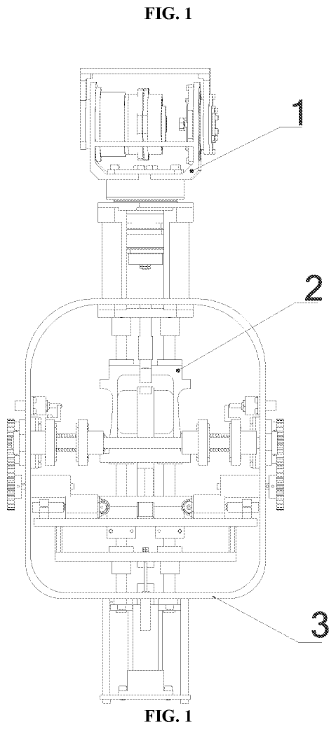

As shown in FIG. 1, the embodiment provides a human cervical vertebra simulation device oriented to rotation-traction manipulation training, which mainly includes a neck motion simulation module 1 and a cervical vertebra pre-traction and lifting-pulling simulation module 2. The simulation device can be connected to a base of a teaching robot by means of a mechanical interface 3. A control and detection system is provided in the base, which can acquire data of transducers loaded on the rotation-traction manipulation teaching robot, transmit the acquired data to the cloud through WiFi or network, and displays, analyzes and operates the acquired data by means of a display.

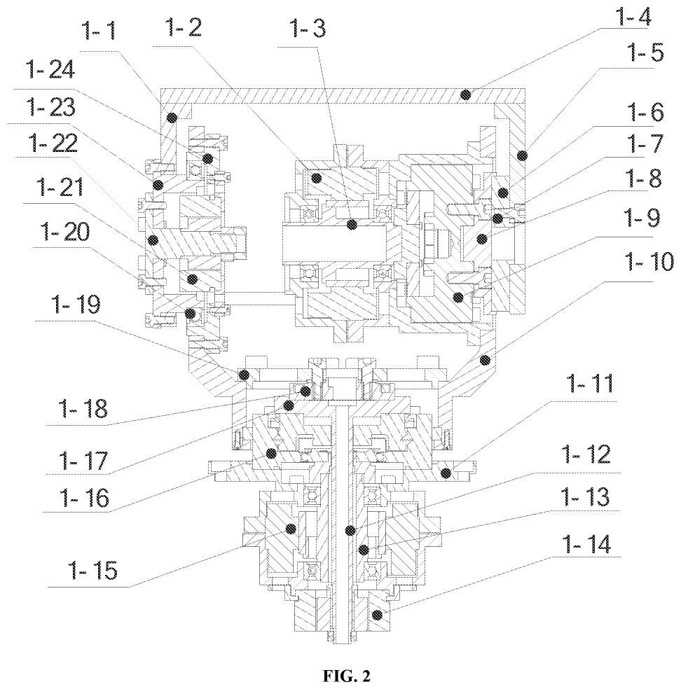

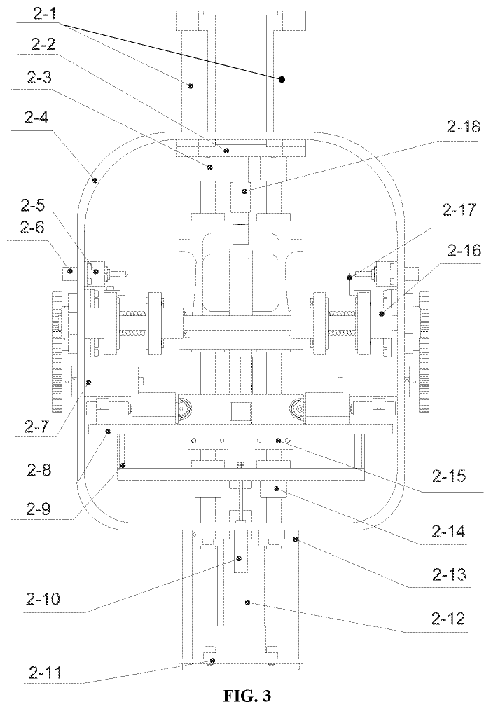

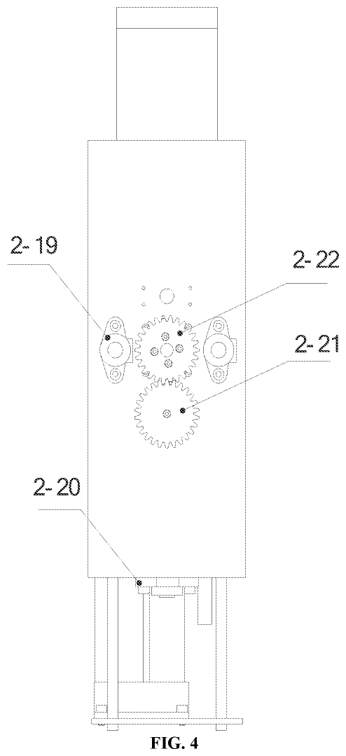

In the embodiment, an internal structure of the neck motion simulation module 1 is as shown in FIG. 2. The module has two degrees of freedom so as to complete functions of rotating and pitching, and is configured to simulate motions in rotating and pitching of the patient's head of two degrees of freedom during the rotation-traction manipulation. The neck motion simulation module 1 mainly includes a pitching follower plate 1-1, a pitching motor 1-2, a pitching motor shaft 1-3, a head mounting plate 1-4, a pitching driving plate 1-5, a pitching torque transducer adapter plate 1-6, a pitching torque transducer 1-8, a pitching harmonic reducer 1-9, a rotating housing 1-10, a neck connecting plate 1-11, a rotating part output shaft 1-12, a rotating motor shaft 1-13, a rotating part rotating transformer 1-14, a rotating motor 1-15, a rotating harmonic reducer 1-16, a flexspline output adapter plate 1-17, a rotating torque transducer 1-18, a rotating driving plate 1-19, a deep groove ball bearing 1-20, a rotating transformer 1-21, a pitching driven shaft 1-22, a driven support 1-23, and a pitching rotating transformer supporting seat 1-24. A housing of the rotating motor 1-15 is connected to the neck connecting plate 1-11 by means of bolts and other fasteners, a motor shaft of the rotating motor 1-15 is connected to a wave generator of the rotating harmonic reducer 1-16, a circular spline of the rotating harmonic reducer 1-16 is fixed to the neck connecting plate 1-11, and the torque is output by a flexspline. As the mechanical interface of the rotating torque transducer 1-18 cannot be in direct fit with a flange interface of the flexspline of the rotating harmonic reducer 1-16, a flexspline output adapter plate 1-17 is designed. One end of the flexspline output adapter plate 1-17 is connected to the flexspline of the rotating harmonic reducer 1-16, the other end of the flexspline output adapter plate 1-17 is connected to one end of the rotating torque transducer 1-18. The other end of the rotating torque transducer 1-18 is fixedly connected to the rotating driving plate 1-19, and the rotating driving plate 1-19 is connected to the rotating housing 1-10 by means of a fastener, thus making the rotating housing 1-10 to rotate in a horizontal direction and achieving a purpose of simulating rotation of the neck. The rotating part harmonic reducer, i.e., the rotating harmonic reducer 1-16, employs a hollow design. The motor shaft of the rotating motor 1-15 also employs the hollow design, output adapter plate 1-17 transmits the decelerated angle to the rotary motor 1-15 through the hollow hole, the rotating motor 1-15 is provided with the rotating part rotating transformer 1-14 to measure an output angle of the rotating part, thus achieving position closed loop. A housing of the pitching motor 1-2 at the pitching part of the neck motion simulation module 1 is fixedly connected to the housing of the pitching harmonic reducer 1-9, the pitching motor shaft 1-3 is connected to a wave generator of the pitching harmonic reducer 1-9, the circular spline of the pitching harmonic reducer 1-9 is fixedly connected to the housing of the pitching motor 1-2, a flexspline of the pitching harmonic reducer is connected to one end of the pitching torque transducer 1-8 by means of the pitching torque transducer adapter plate 1-6, and the other end of the pitching torque transducer 1-8 is connected to the pitching driving plate 1-5. An upper end of the head mounting plate 1-4 is configured to connect a simulated human head of a teaching robot, a right end of the head mounting plate 1-4 is connected to the pitching driving plate 1-5, the motion is transferred to the left side through the head mounting plate 1-4, and the pitching follower plate 1-1 is used for assisting in supporting the head mounting plate 1-4 and the load of the head. The pitching follower plate 1-1 is connected to the driven support 1-23, the driven support 1-23 is connected to an inner ring of the deep groove ball bearing 1-20, and an outer ring of the deep groove ball bearing 1-20 is connected to the rotating housing 1-10. To measure the pitching angle, a stator portion of the pitching part rotating transformer 1-21 is connected to the rotating housing 1-10, a rotor portion of the pitching part rotating transformer 1-21 is connected to the pitching driven shaft 1-22, the pitching driven shaft 1-22 is fixedly connected to the driven support 1-23 by means of a flange, and the pitching angle can be measured through the relative movement of the pitching portion and the rotating housing 1-10.

In the embodiment, the cervical vertebra pre-traction and lifting-pulling simulation module 2 is mainly configured to simulate the motion changes and states of the cervical vertebra of a patient in the manipulation process, and mainly includes a neck connecting plate 2-1, an adapter plate 2-2, a linear bearing 2-3, a shell 2-4, a displacement transducer mounting plate 2-5, a linear displacement transducer 2-6, a pre-traction stiffness adjusting motor 2-7, a lifting-pulling base 2-8, a base sliding supporting plate 2-9, a base movement displacement transducer 2-10, a base push rod holder 2-11, a lifting-pulling base linear push rod 2-12, a base push rod pillar 2-13, a linear bearing 2-14, a base stop block 2-15, a pre-traction module 2-16, a pre-traction stiffness measurement tooling plate 2-17, a tension and pressure transducer 2-18, a transverse polished shaft fixing seat 2-19, a longitudinal polished shaft fixing seat 2-20, a stiffness adjusting gear 2-21, a driven gear 2-22, a longitudinal polished shaft 2-23, a pre-traction slide block 2-24, a lifting-pulling module 2-25, a transverse linear bearing 2-26, a transverse polished shaft 2-27, a pre-traction spring 2-28, a pulley block 2-29, and first rollers 2-30. According to the characteristics of the rotation-traction manipulation, the cervical vertebra pre-traction and lifting-pulling simulation module 2 is mainly achieved by mechanical and control of the pre-traction module 2-16 and the lifting-pulling module 2-25.

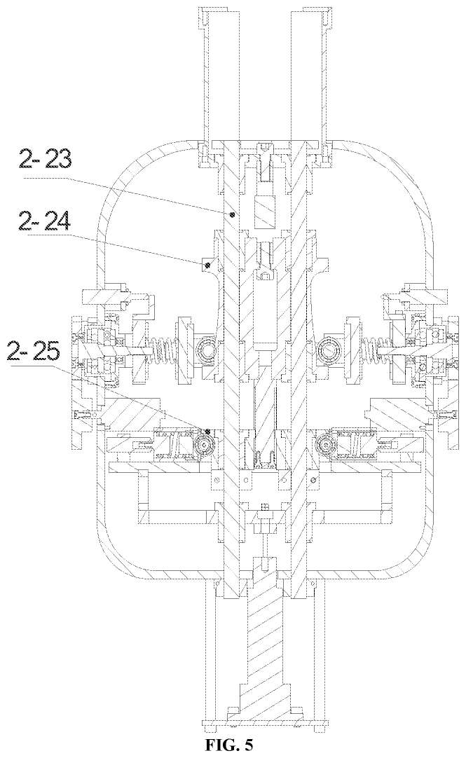

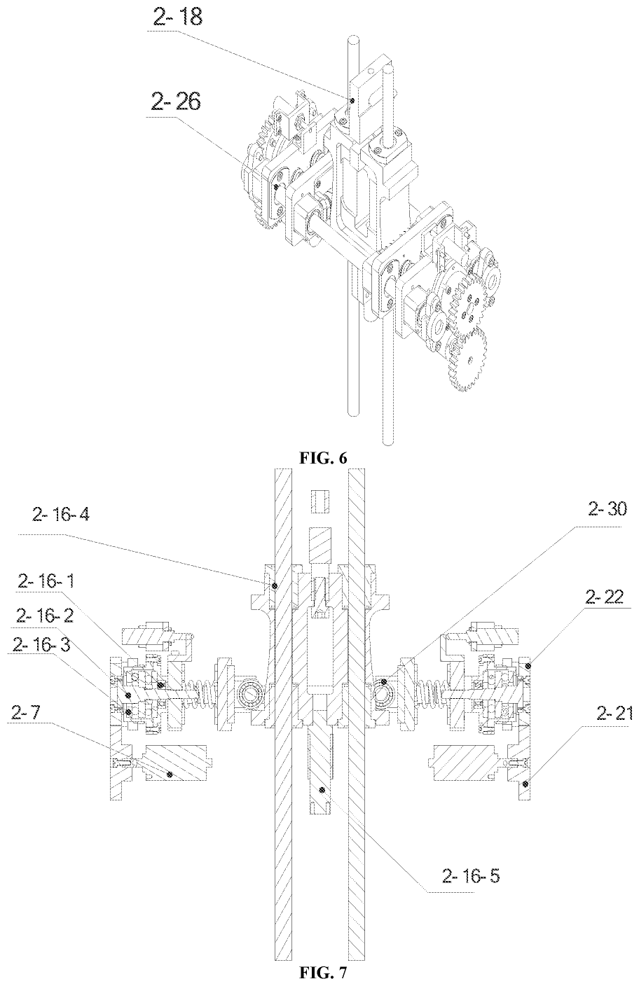

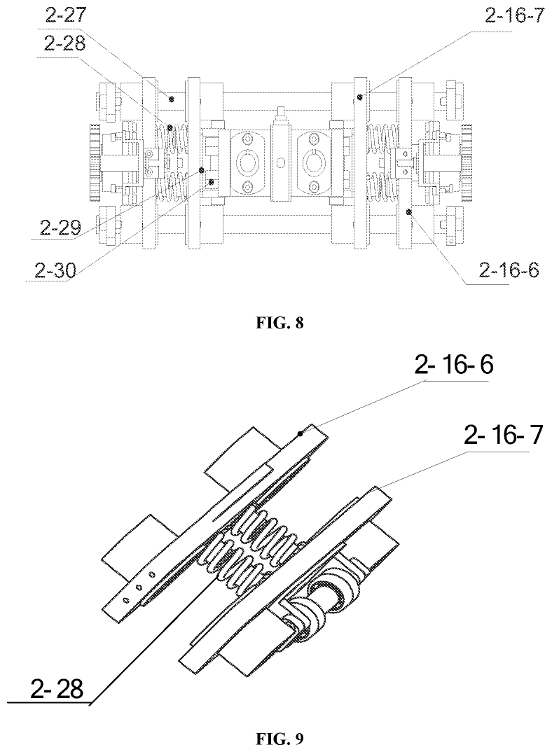

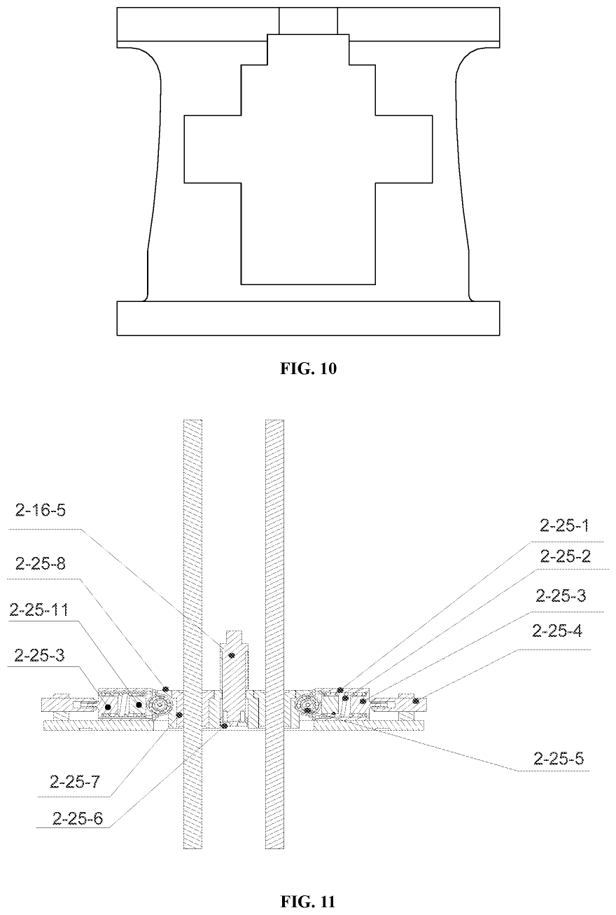

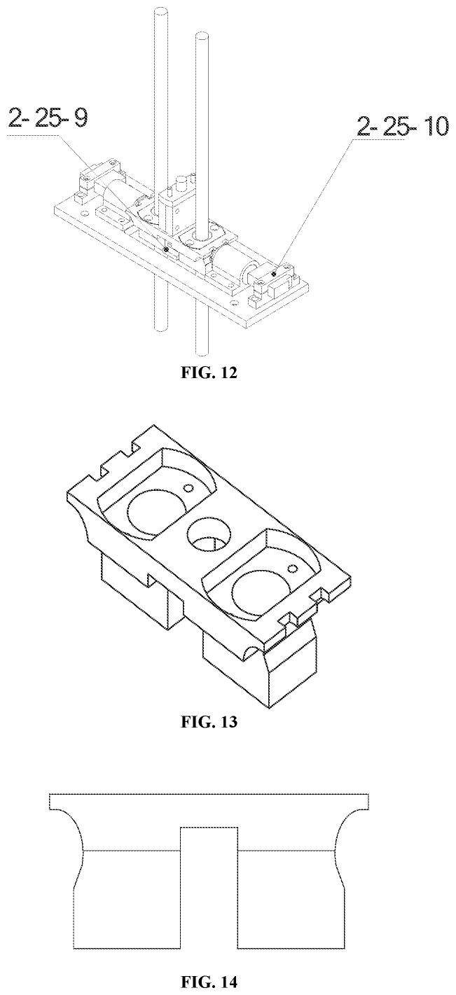

(1) The pre-traction module 2-16 is configured to simulate the pre-loading process of the manipulation, the force in the preloading process is in an obvious non-linear change, and in order to satisfy the requirements above, a variable-stiffness mechanism is fabricated, as shown in FIG. 6 to FIG. 9. The upper end of the neck connecting plate 2-1 is connected to a neck connecting plate 1-11 in the neck simulation device (i.e., the neck motion simulation module 1), the lower end of the neck connecting plate 2-1 is connected to the adapter plate 2-2, and the adapter plate 2-2 is connected to the pre-traction slide block 2-24 by the tension and pressure transducer 2-18. To ensure that the pre-traction slide block 2-24 can only move linearly, two longitudinal polished shafts 2-23 and linear bearings are adopted to achieve axial movement of components such as the pre-traction slide block 2-24; and in order to achieve balanced stress, the two longitudinal polished shafts 2-23 are of a symmetrical structure. The variable-stiffness mechanism is mainly supported by the transverse polished shaft 2-27, and the transverse polished shaft 2-27 is fixed to two sides of the shell 2-4 by means of transverse polished shaft fixing seats 2-19. The housing of the pre-traction stiffness adjusting motor 2-7 is fixedly connected to the shell 2-4, a rotating main shaft of the pre-traction stiffness adjusting motor 2-7 is connected to the stiffness adjusting gear 2-21 by means of a fastener, the stiffness adjusting gear 2-21 is meshed with the driven gear 2-22, the pre-traction loading shaft 2-16-2 is connected to the driven gear 2-22 by means of a flange, and the other end of the pre-traction loading shaft 2-26-2 is provided with threads so as to be in threaded fit with the first pre-traction loading plate 2-16-6. The pre-traction loading shaft 2-16-2, the first pre-traction loading plate 2-16-6 and the transverse polished shaft 2-27 form a lead screw slide block mechanism. The pre-traction loading shaft 2-16-2 is driven by the driven gear 2-22 to rotate so as to achieve the axial movement of the first pre-traction loading plate 2-16-6 along the transverse polished shaft 2-27. The first pre-traction loading plate 2-16-6 is connected to the second pre-traction loading plate 2-16-7 by means of the preloading spring 2-28, and thus the pre-traction stiffness can be adjusted by the first pre-traction loading plate 2-16-6. The pulley block 2-29 is mounted on one end, away from the first pre-traction loading plate 2-16-6, of the second pre-traction loading plate 2-16-7. The first rollers 2-30 are rotatably mounted on the pulley block 2-29 and may move along the special-shaped curved surfaces at two sides of the pre-traction slide block 2-24, and the pre-traction variable-stiffness effect can be achieved by squeezing the second pre-traction loading plate 2-16-7. The pre-traction stiffness adjusting motor 2-7 may achieve different initial positions of the first pre-traction loading plate 2-16-6 by means of control, and the position of the first pre-traction loading plate 2-16-6 can be measured by means of the linear displacement transducer 2-6, thereby achieving the simulation of individualized human cervical vertebra during pre-traction. Moreover, during pre-traction, the pre-traction stiffness adjusting motor 2-7 may be controlled in real time to achieve the stiffness simulation of the individualized symptom.

In the embodiment, loading curved surfaces on two sides of the pre-traction slide block 2-24 are not planes or smooth curved surfaces but special-shaped curved shapes, as shown in FIG. 10. The loading curved surfaces of the pre-traction slide block 2-24 gradually incline towards the outer side from top to bottom, a main body of the pre-traction slide block 2-24 is narrow in the upper part and wide in the lower part, limiting baffles are arranged at the upper end and the lower end of the pre-traction slide block 2-24, respectively. The two ends of each limiting baffle extend out of the loading curved surfaces on two sides to play a role in limiting, thus preventing the first rollers 2-30 from slipping from the upper end or the lower end of the loading curved surfaces. The pre-traction slide block 2-24 is subjected to the squeeze action of the first rollers 2-30 on two sides, the position of the pre-traction slide block 2-24 on the longitudinal polished shaft 2-23 can be changed by adjusting the pressing force of the first rollers 2-30 on the loading curved surfaces, then the pre-traction resistance applied to the pre-traction slide block 2-24 by the first rollers 2-30 can be changed. The pre-traction resistance corresponds to the pre-traction force applied by a student and is detected by the tension and pressure transducer 2-18. In the process of applying pre-traction force by the student, the pre-traction slide block 2-24 ascends gradually, the first rollers 2-30 are pressed against the loading curved surfaces of the pre-traction slide block 2-24 tightly under the action of the pre-traction springs 2-28. Based on structural features of the loading curved surfaces, the pressing force of the first rollers 2-30 on the pre-traction slide block 2-24 is dynamically changed and is in non-linear change. During actual operation, the pressing force of the first rollers 2-30 on the pre-traction slide block 2-24 is increased by the pre-traction stiffness adjusting motor 2-7 to force the pre-traction slide block 2-24 to move downwards, thus increasing the pre-traction resistance. In contrast, the pressing force of the first rollers 2-30 on the pre-traction slide block 2-24 is reduced by the pre-traction stiffness adjusting motor 2-7, thus reducing the pre-traction resistance.

Furthermore, due to the counter-acting force of the pre-traction slide block 2-24, the pre-traction loading shaft 2-16-2 is subjected to both axial force and radial force, and therefore the thrust bearing 2-16-3 and the deep groove ball bearing 2-16-1 in a bidirectional plane are designed to support the pre-traction loading shaft 2-16-2. A pre-traction-lifting pulling connecting pin 2-16-5 is designed at the lower end of the pre-traction slide block 2-24 to be in fit with the lifting-pulling baffle 2-25-6 to transfer the force to the lifting-pulling module 2-25.

(2) After the pre-traction process is finished, the lifting-pulling process is started. During pre-traction, the lifting-pulling module 2-25 does not work, and thus the pre-traction-lifting-pulling connecting pin 2-16-5 is designed, such pin may penetrate through the center hole of the lifting-pulling module 2-25-8, when the pin reaches the pre-traction position, an operator may feel obvious increase of resistance. The bottom of the pre-traction-lifting-pulling connecting pin 2-16-5 is connected to the lifting-pulling baffle 2-25-6 by means of a flange, the area of the lifting-pulling baffle 2-25-6 is greater than that of the center hole of 2-25-8, and thus the operator can only feel the variable stiffness generated by the pre-traction slide block 2-24 during pre-traction. After the pre-traction is finished, the lifting-pulling baffle 2-25-6 moves upwards along with the traction-lifting-pulling connecting pin 2-16-5 and is in contact with the lifting-pulling slide block 2-25-8, and thus the operator may feel the obvious increase of the resistance. Through the force analysis of the lifting-pulling process, it can be known that the stiffness of cervical vertebra may suddenly change during the lifting-pulling. Therefore, by employing a design concept similar to the pre-traction module, the sudden change of the stiffness of the cervical vertebra during lifting-pulling can be simulated in a manner of pressing the curved surface by springs.

The lifting-pulling module 2-25 mainly includes a lifting-pulling housing 2-25-1, a lifting-pulling spring 2-25-2, a first lifting-pulling loading pin 2-25-3, a linear push rod 2-25-4, a lifting-pulling pulley 2-25-5, a lifting-pulling baffle 2-25-6, a lifting-pulling linear bearing 2-25-7, a lifting-pulling slide block 2-25-8, a rubber gasket 2-25-9, and a linear push rod fixing seat 2-25-10. The linear push rod 2-25-4 is a driving element and is fixed to a lifting-pulling base 2-8 by a linear push rod fixing seat 2-25-10, and the lifting-pulling housing 2-25-1 is also fixed to a lifting-pulling base 2-8. The linear push rod 2-25-4 may be an electric telescopic rod, and may also a straight rod driven by a worm gear and other mechanical structures. An extending end of the linear push rod 2-25-4 is fixedly connected to the first lifting-pulling loading pin 2-25-3, the first lifting-pulling loading pin 2-25-3 is connected to a second lifting-pulling loading pin 2-25-11 by the lifting-pulling spring 2-25-2, and the simulation of the lifting-pulling stiffness can be achieved by controlling the linear push rod 2-25-4 to stretch out and draw back. The second lifting-pulling loading pin 2-25-11 is connected to the second roller 2-25-5, the second roller 2-25-5 may roll on the lifting-pulling slide block 2-25-8, when the rolling of the second roller exceeds the displacement of the lifting-pulling, the second roller 2-25-5 may be separated from the slideway of the lifting-pulling slide block 2-25-8, and thus the joint capsule separation simulation is achieved. An upper surface of the lifting-pulling baffle 2-25-6 is provided with a rubber gasket 2-25-9, during lifting-pulling, the rubber gasket 2-25-9 is in contact with the lifting-pulling slide block 2-25-8 at first, thus avoiding equipment damage caused by collision between metals in the process of converting pre-traction into lifting-pulling. Through holes are symmetrically formed in two sides of the lifting-pulling slide block 2-25-8 so as to mount the lifting-pulling linear bearing 2-25-7. The longitudinal polished shafts 2-23 penetrate through the linear bearing 2-25-7 to ensure the vertical movement of the lifting-pulling slide block 2-25-8 during lift-pulling.

In the embodiment, a control and detection system in communication connection with the human cervical vertebra simulation device oriented to rotation-traction manipulation training can be arranged on the teaching robot. When the neck motion simulation module moves to a designated position, position control is adopted, when the neck motion simulation module reaches a manipulation position, the neck motion simulation module is switched to impedance control, and based on the impedance control, the joints of the robot are enabled to move by corresponding angles in a stiffness setting manner according to the magnitude of the force applied by the operator. The impedance control is an existing robot impedance control strategy and will not be repeated here. Therefore, it can serve as an indicator to determine whether the manipulation is to apply force vertically upwards. A force transducer, a displacement transducer, an acceleration transducer and other sensing detection elements are arranged in the control and detection system, thus the control and detection system can complete the acquisition of parameters of motors and the transducers in the human cervical vertebra simulation device oriented to rotation-traction manipulation training by means of a circuit, and upload the parameters to a cloud platform to be displayed, processed and analyzed at the local terminal.

In conclusion, according to the individualized cervical vertebra mechanical simulation device oriented to rotation-traction manipulation training provided by the technical solution, mechanical simulation of individualized symptoms of the rotation-traction manipulation can be achieved through the two variable-stiffness modules (the pre-traction module and the lifting-pulling module), and detection of a pre-traction angle and a lifting-pulling angle can be achieved by means of the impedance control technology; and the measurement of the manipulation parameters can be completed by the transducers arranged in the simulation device. In accordance with the technical solution, the human cervical vertebra simulation device oriented to rotation-traction manipulation training is suitable for beginners to learn and master the rotation-traction manipulation, can be used as one of reference indicators for manipulation examination, can be used as an experimental platform for manipulation teaching, and can be configured to perform standardized examination on the operation manipulation, thus facilitating the promotion and the popularization of the rotation-traction manipulation.

### Embodiment 2

The embodiment provides a teaching robot, including a simulated human head, a base, and the human cervical vertebra simulation device oriented to rotation-traction manipulation training as described in Embodiment 1. The simulated human head is mounted on the neck connecting plate 11 of the human cervical vertebra simulation device oriented to rotation-traction manipulation training, and the shell 2-4 is provided with the mechanical interface 3 for being connected to the base. The teaching robot is further configured with a control system and a cloud platform. The control system may be configured to acquire parameters of the motors and the transducers in the human cervical vertebra simulation device oriented to rotation-traction manipulation training by means of a circuit, to transmit the acquired parameters to the cloud platform through the WiFi or the network, and to complete display, processing and analysis of the parameters at the local terminal. The specific structural arrangement, the operating principle and the technical effects of the human cervical vertebra simulation device oriented to rotation-traction manipulation training are illustrated in Embodiment 1 one by one and will not be repeated here.

It should be noted that: for those skilled in the art, apparently, the present disclosure is not limited to details of the exemplary embodiments, and may be expressed in other specific forms without departing from the spirit or basic characteristics of the present disclosure. Therefore, in any way, the embodiments should be regarded as exemplary, not limitative; and the scope of the present disclosure is limited by the appended claims, instead of the above description. Thus, all variations intended to fall into the meaning and scope of equivalent elements of the claims should be covered within the present disclosure. Any reference signs in the claims shall not be regarded as limitations to the concerned claims.

Several examples are used for illustration of the principles and implementation methods of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

1. A human cervical vertebra simulation device oriented to rotation-traction manipulation training, comprising:
a neck motion simulation module, comprising a rotating housing, a neck connecting plate, a rotating drive, a pitching drive, and a head mounting plate, wherein the neck connecting plate is located below the rotating housing, the rotating drive is arranged on the neck connecting plate and is connected to a lower part of the rotating housing; the rotating drive is configured to drive the rotating housing to rotate so as to simulate rotation action of a neck of a patient during rotation-traction manipulation; the pitching drive is mounted at an upper part of the rotating housing by a fastener, is connected to the head mounting plate and configured to drive the head mounting plate to rotate with respect to the rotating housing, thus simulating pitch action of the neck of the patient during the rotation-traction manipulation; and
a cervical vertebra pre-traction and lifting-pulling simulation module, comprising a shell, a pre-traction module, and a lifting-pulling module; the pre-traction module is arranged in the shell, and comprises a pre-traction damping mechanism, and a neck connecting plate, an adapter plate, a tension and pressure detection device and a pre-traction slide block connected in sequence from top to bottom; an upper part of the neck connecting plate penetrates through the housing and is connected to the neck connecting plate; the pre-traction damping mechanism is arranged on the shell and configured to apply pre-traction resistance on the pre-traction slide block; the lifting-pulling module is arranged in the shell and comprises a lifting-pulling slide block and a lifting-pulling damping mechanism; the lifting-pulling slide block is located below the pre-traction slide block, the pre-traction slide block is connected to the lifting-pulling slide block by means of a pre-traction-lifting-pulling connecting pin; a lower part of the pre-traction-lifting-pulling connecting pin penetrates through the lifting-pulling slide block and is connected to a lifting-pulling baffle; when the pre-traction slide block is not in a pre-traction state, the lifting-pulling baffle is located below the lifting-pulling slide block and spaced from the lifting-pulling slide block; when the pre-traction slide block is in a pre-traction completing state, the lifting-pulling baffle abuts against the lifting-pulling slide block and continues to pull the pre-traction slide block; the lifting-pulling slide block can be lifted and pulled by the lifting-pulling baffle so as to simulate rigidity sudden change of cervical vertebra in the lifting-pulling process; and the lifting-pulling damping mechanism is arranged on the shell and configured to apply lifting-pulling resistance to the lifting-pulling slide block.

2. The human cervical vertebra simulation device according to claim 1, wherein the rotating drive comprises a rotating part rotating transformer, and a rotating motor, a rotating part reducer, a rotating torque detection device and a rotating driving plate connected in sequence; the rotating motor is arranged on the neck connecting plate, and the rotating driving plate is connected to the rotating housing, and the rotating part rotating transformer is connected to a rotating shaft of the rotating motor so as to measure a rotation angle of the rotating shaft.

3. The human cervical vertebra simulation device according to claim 2, wherein the pitching drive comprises a pitching part rotating transformer, and a pitching motor, a pitching part reducer, a pitching torque detection device and a pitching driving plate which are connected in sequence; the pitching motor is arranged on an inner wall of the rotating housing, the pitching driving plate is connected to a side of the head mounting plate, and a pitching follower plate and a driven support are connected to an other side of the head mounting plate in sequence; the driven support is rotatably connected to an other side of the rotating housing by means of a pitching driven shaft, and the pitching part rotating transformer is connected to the pitching driven shaft so as to measure a pitching angle of the pitching driven shaft.

4. The human cervical vertebra simulation device according to claim 1, wherein loading curved surfaces are symmetrically arranged on two sides of the pre-traction slide block and gradually incline outwards from top to bottom;
the pre-traction damping mechanism comprises a variable-stiffness driving mechanism and a first roller; the variable-stiffness driving mechanism is mounted on the shell, the first roller is rotatably mounted on the variable-stiffness driving mechanism, the first roller is pressed against each loading curved surface by the variable-stiffness driving mechanism; two sides of the pre-traction slide block are arranged on the pre-traction damping mechanism, and pre-traction resistance applied to the pre-traction slide block by the pre-traction damping mechanism is adjusted by adjusting pressing force of the first roller to the loading curved surface.

5. The human cervical vertebra simulation device according to claim 4, wherein the variable-stiffness driving mechanism comprises:
a transverse polished shaft, wherein two ends of the transverse polished shaft are fixedly arranged on two sidewalls of the shell;
a first pre-traction loading plate, wherein the first pre-traction loading plate is slidingly sleeved on the transverse polished shaft;
a second pre-traction loading plate, wherein the second pre-traction loading plate is slidingly sleeved on the transverse polished shaft and is located between the first pre-traction loading plate and the pre-traction slide block; the second pre-traction loading plate is connected to the first pre-traction loading plate by means of a pre-traction spring, and the first roller is mounted on a side, away from the first pre-traction loading plate, of the second pre-traction loading plate;
a pre-traction loading shaft, wherein an end of the pre-traction loading shaft penetrates through the first pre-traction loading plate and is threaded to the first pre-traction loading plate;
a pre-traction stiffness adjusting motor, wherein the pre-traction stiffness adjusting motor is arranged on an sidewall of the shell, a stiffness adjusting gear is connected to an output shaft of the pre-traction stiffness adjusting motor, the stiffness adjusting gear is meshed with a driven gear, the stiffness adjusting gear and the driven gear are both rotatably mounted on the sidewall of the shell, the driven gear is connected to an other end of the pre-traction loading shaft, the pre-traction stiffness adjusting motor is able to drive the first pre-traction loading plate to move towards the second pre-traction loading plate, thus adjusting the pressing force of the first roller on the loading curved surface; and
a linear displacement transducer, wherein the linear displacement transducer is arranged on the sidewall of the shell and is connected to the first pre-traction loading plate so as to detect a position of the first pre-traction loading plate on the transverse polished shaft.

6. The human cervical vertebra simulation device according to claim 1, wherein the lifting-pulling damping mechanism comprises:
a lifting-pulling base, wherein the lifting-pulling base is connected to a lower part of the lifting-pulling slide block;
a lifting-pulling housing, wherein the lifting-pulling housing is arranged on the lifting-pulling base and located on a side of the lifting-pulling slide block, and a sliding chute cavity parallel to the transverse polished shaft is formed inside the lifting-pulling housing;
a first lifting-pulling loading pin, wherein the first lifting-pulling loading pin is slidingly nested in the sliding chute cavity;
a second lifting-pulling loading pin, wherein the second lifting-pulling loading pin is slidingly nested in the sliding chute cavity and located between the first lifting-pulling loading pin and the lifting-pulling slide block; the second lifting-pulling loading pin is connected to the first lifting-pulling loading pin by means of a lifting-pulling spring, a second roller is mounted on an end, away from the first lifting-pulling loading pin, of the second lifting-pulling loading pin, and the second roller is in contact with a sidewall of the lifting-pulling slide block; and
a linear push rod, wherein the linear push rod is arranged on the lifting-pulling base by means of a linear push rod fixing seat, the linear push rod is connected to the first lifting-pulling loading pin and is able to drive the first lifting-pulling loading pin to move towards, or away from, the second lifting-pulling loading pin, thereby adjusting pressing force of the second roller on the sidewall of the lifting-pulling slide block.

7. The human cervical vertebra simulation device according to claim 6, further comprising a longitudinal polished shaft, wherein two ends of the longitudinal polished shaft are fixedly connected to an upper part and a lower part of the shell respectively;
the adapter plate, the pre-traction slide block and the lifting-pulling slide block are slidingly sleeved on the longitudinal polished shaft;
a base sliding supporting plate is connected to a lower part of the lifting-pulling base, the base sliding supporting plate is slidingly sleeved on the longitudinal polished shaft; a base stop block is fixedly arranged on the longitudinal polished shaft between the lifting-pulling base and the base sliding supporting plate, and the base stop block is able to limit a lower limit of downward movement of the lifting-pulling plate base and an upper limit of upward movement of the base sliding supporting plate.

8. The human cervical vertebra simulation device according to claim 1, wherein an upper surface of the lifting-pulling baffle is provided with a rubber gasket, and the lifting-pulling baffle abuts against the lifting-pulling slide block by means of the rubber gasket.

9. A teaching robot oriented to rotation-traction manipulation training, comprising a cloud platform, a control system, and a human cervical vertebra simulation device oriented to rotation-traction manipulation training, wherein the human cervical vertebra simulation device comprises:
a neck motion simulation module, comprising a rotating housing, a neck connecting plate, a rotating drive, a pitching drive, and a head mounting plate, wherein the neck connecting plate is located below the rotating housing, the rotating drive is arranged on the neck connecting plate and is connected to a lower part of the rotating housing; the rotating drive is configured to drive the rotating housing to rotate so as to simulate rotation action of a neck of a patient during rotation-traction manipulation; the pitching drive is mounted at an upper part of the rotating housing by a fastener, is connected to the head mounting plate and configured to drive the head mounting plate to rotate with respect to the rotating housing, thus simulating pitch action of the neck of the patient during the rotation-traction manipulation; and
a cervical vertebra pre-traction and lifting-pulling simulation module, comprising a shell, a pre-traction module, and a lifting-pulling module; the pre-traction module is arranged in the shell, and comprises a pre-traction damping mechanism, and a neck connecting plate, an adapter plate, a tension and pressure detection device and a pre-traction slide block connected in sequence from top to bottom; an upper part of the neck connecting plate penetrates through the housing and is connected to the neck connecting plate; the pre-traction damping mechanism is arranged on the shell and configured to apply pre-traction resistance on the pre-traction slide block; the lifting-pulling module is arranged in the shell and comprises a lifting-pulling slide block and a lifting-pulling damping mechanism; the lifting-pulling slide block is located below the pre-traction slide block, the pre-traction slide block is connected to the lifting-pulling slide block by means of a pre-traction-lifting-pulling connecting pin; a lower part of the pre-traction-lifting-pulling connecting pin penetrates through the lifting-pulling slide block and is connected to a lifting-pulling baffle; when the pre-traction slide block is not in a pre-traction state, the lifting-pulling baffle is located below the lifting-pulling slide block and spaced from the lifting-pulling slide block; when the pre-traction slide block is in a pre-traction completing state, the lifting-pulling baffle abuts against the lifting-pulling slide block and continues to pull the pre-traction slide block; the lifting-pulling slide block can be lifted and pulled by the lifting-pulling baffle so as to simulate rigidity sudden change of cervical vertebra in the lifting-pulling process; and the lifting-pulling damping mechanism is arranged on the shell and configured to apply lifting-pulling resistance to the lifting-pulling slide block;
wherein the control system is in communication connection with the cloud platform, the rotating drive, the pitching drive, the pre-traction damping mechanism, the tension and pressure detection device and the lifting-pulling damping mechanism; the cloud platform is configured to display, process and analyze operating parameters of the rotating drive, the pitching drive, the pre-traction damping mechanism, the tension and pressure detection device and the lifting-pulling damping mechanism.

10. The teaching robot according to claim 9, further comprising a simulated human head and a base, wherein the simulated human head is arranged on the head mounting plate, a lower part of the shell is connected to the base by means of a mechanical interface, and the control system is arranged in the base.

11. The human cervical vertebra simulation device according to claim 2, wherein loading curved surfaces are symmetrically arranged on two sides of the pre-traction slide block and gradually incline outwards from top to bottom;
the pre-traction damping mechanism comprises a variable-stiffness driving mechanism and a first roller; the variable-stiffness driving mechanism is mounted on the shell, the first roller is rotatably mounted on the variable-stiffness driving mechanism, the first roller is pressed against each loading curved surface by the variable-stiffness driving mechanism;
two sides of the pre-traction slide block are arranged on the pre-traction damping mechanism, and pre-traction resistance applied to the pre-traction slide block by the pre-traction damping mechanism is adjusted by adjusting pressing force of the first roller to the loading curved surface.

12. The human cervical vertebra simulation device according to claim 3, wherein loading curved surfaces are symmetrically arranged on two sides of the pre-traction slide block and gradually incline outwards from top to bottom;
the pre-traction damping mechanism comprises a variable-stiffness driving mechanism and a first roller; the variable-stiffness driving mechanism is mounted on the shell, the first roller is rotatably mounted on the variable-stiffness driving mechanism, the first roller is pressed against each loading curved surface by the variable-stiffness driving mechanism; two sides of the pre-traction slide block are arranged on the pre-traction damping mechanism, and pre-traction resistance applied to the pre-traction slide block by the pre-traction damping mechanism is adjusted by adjusting pressing force of the first roller to the loading curved surface.

13. The teaching robot according to claim 9, wherein the rotating drive comprises a rotating part rotating transformer, and a rotating motor, a rotating part reducer, a rotating torque detection device and a rotating driving plate connected in sequence; the rotating motor is arranged on the neck connecting plate, and the rotating driving plate is connected to the rotating housing, and the rotating part rotating transformer is connected to a rotating shaft of the rotating motor so as to measure a rotation angle of the rotating shaft.

14. The teaching robot according to claim 13, wherein the pitching drive comprises a pitching part rotating transformer, and a pitching motor, a pitching part reducer, a pitching torque detection device and a pitching driving plate which are connected in sequence; the pitching motor is arranged on an inner wall of the rotating housing, the pitching driving plate is connected to a side of the head mounting plate, and a pitching follower plate and a driven support are connected to an other side of the head mounting plate in sequence; the driven support is rotatably connected to an other side of the rotating housing by means of a pitching driven shaft, and the pitching part rotating transformer is connected to the pitching driven shaft so as to measure a pitching angle of the pitching driven shaft.

15. The teaching robot according to claim 9, wherein loading curved surfaces are symmetrically arranged on two sides of the pre-traction slide block and gradually incline outwards from top to bottom;
the pre-traction damping mechanism comprises a variable-stiffness driving mechanism and a first roller; the variable-stiffness driving mechanism is mounted on the shell, the first roller is rotatably mounted on the variable-stiffness driving mechanism, the first roller is pressed against each loading curved surface by the variable-stiffness driving mechanism;
two sides of the pre-traction slide block are arranged on the pre-traction damping mechanism, and pre-traction resistance applied to the pre-traction slide block by the pre-traction damping mechanism is adjusted by adjusting pressing force of the first roller to the loading curved surface.

16. The teaching robot according to claim 13, wherein loading curved surfaces are symmetrically arranged on two sides of the pre-traction slide block and gradually incline outwards from top to bottom;
the pre-traction damping mechanism comprises a variable-stiffness driving mechanism and a first roller; the variable-stiffness driving mechanism is mounted on the shell, the first roller is rotatably mounted on the variable-stiffness driving mechanism, the first roller is pressed against each loading curved surface by the variable-stiffness driving mechanism;
two sides of the pre-traction slide block are arranged on the pre-traction damping mechanism, and pre-traction resistance applied to the pre-traction slide block by the pre-traction damping mechanism is adjusted by adjusting pressing force of the first roller to the loading curved surface.

17. The teaching robot according to claim 14, wherein loading curved surfaces are symmetrically arranged on two sides of the pre-traction slide block and gradually incline outwards from top to bottom;
the pre-traction damping mechanism comprises a variable-stiffness driving mechanism and a first roller; the variable-stiffness driving mechanism is mounted on the shell, the first roller is rotatably mounted on the variable-stiffness driving mechanism, the first roller is pressed against each loading curved surface by the variable-stiffness driving mechanism; two sides of the pre-traction slide block are arranged on the pre-traction damping mechanism, and pre-traction resistance applied to the pre-traction slide block by the pre-traction damping mechanism is adjusted by adjusting pressing force of the first roller to the loading curved surface.

18. The teaching robot according to claim 15, wherein the variable-stiffness driving mechanism comprises:
a transverse polished shaft, wherein two ends of the transverse polished shaft are fixedly arranged on two sidewalls of the shell;
a first pre-traction loading plate, wherein the first pre-traction loading plate is slidingly sleeved on the transverse polished shaft;
a second pre-traction loading plate, wherein the second pre-traction loading plate is slidingly sleeved on the transverse polished shaft and is located between the first pre-traction loading plate and the pre-traction slide block; the second pre-traction loading plate is connected to the first pre-traction loading plate by means of a pre-traction spring, and the first roller is mounted on a side, away from the first pre-traction loading plate, of the second pre-traction loading plate;
a pre-traction loading shaft, wherein an end of the pre-traction loading shaft penetrates through the first pre-traction loading plate and is threaded to the first pre-traction loading plate;
a pre-traction stiffness adjusting motor, wherein the pre-traction stiffness adjusting motor is arranged on an sidewall of the shell, a stiffness adjusting gear is connected to an output shaft of the pre-traction stiffness adjusting motor, the stiffness adjusting gear is meshed with a driven gear, the stiffness adjusting gear and the driven gear are both rotatably mounted on the sidewall of the shell, the driven gear is connected to an other end of the pre-traction loading shaft, the pre-traction stiffness adjusting motor is able to drive the first pre-traction loading plate to move towards the second pre-traction loading plate, thus adjusting the pressing force of the first roller on the loading curved surface; and
a linear displacement transducer, wherein the linear displacement transducer is arranged on the sidewall of the shell and is connected to the first pre-traction loading plate so as to detect a position of the first pre-traction loading plate on the transverse polished shaft.

19. The teaching robot according to claim 9, wherein the lifting-pulling damping mechanism comprises:
a lifting-pulling base, wherein the lifting-pulling base is connected to a lower part of the lifting-pulling slide block;
a lifting-pulling housing, wherein the lifting-pulling housing is arranged on the lifting-pulling base and located on a side of the lifting-pulling slide block, and a sliding chute cavity parallel to the transverse polished shaft is formed inside the lifting-pulling housing;
a first lifting-pulling loading pin, wherein the first lifting-pulling loading pin is slidingly nested in the sliding chute cavity;
a second lifting-pulling loading pin, wherein the second lifting-pulling loading pin is slidingly nested in the sliding chute cavity and located between the first lifting-pulling loading pin and the lifting-pulling slide block; the second lifting-pulling loading pin is connected to the first lifting-pulling loading pin by means of a lifting-pulling spring, a second roller is mounted on an end, away from the first lifting-pulling loading pin, of the second lifting-pulling loading pin, and the second roller is in contact with a sidewall of the lifting-pulling slide block; and
a linear push rod, wherein the linear push rod is arranged on the lifting-pulling base by means of a linear push rod fixing seat, the linear push rod is connected to the first lifting-pulling loading pin and is able to drive the first lifting-pulling loading pin to move towards, or away from, the second lifting-pulling loading pin, thereby adjusting pressing force of the second roller on the sidewall of the lifting-pulling slide block.

20. The teaching robot according to claim 19, further comprising a longitudinal polished shaft, wherein two ends of the longitudinal polished shaft are fixedly connected to an upper part and a lower part of the shell respectively;
the adapter plate, the pre-traction slide block and the lifting-pulling slide block are slidingly sleeved on the longitudinal polished shaft;
a base sliding supporting plate is connected to a lower part of the lifting-pulling base, the base sliding supporting plate is slidingly sleeved on the longitudinal polished shaft; a base stop block is fixedly arranged on the longitudinal polished shaft between the lifting-pulling base and the base sliding supporting plate, and the base stop block is able to limit a lower limit of downward movement of the lifting-pulling plate base and an upper limit of upward movement of the base sliding supporting plate.
